(19) United States
(12) Patent Application Publication
(10) Pub. No.: US 2020/0207908 A1
(43) Pub. Date: Jul. 2, 2020

(54) METHOD FOR IMPROVED STABILITY OF POLYURETHANE FOAM MADE WITH A HYDROHALOOLEFIN BLOWING AGENT

(71) Applicants: Dow Silicones Corporation, Midland, MI (US); Dow Global Technologies LLC, Midland, MI (US)

(72) Inventors: Noel Mower Chang, Midland, MI (US); Simon Toth, Midland, MI (US); Weston Tulloch, Bay City, MI (US); Anna M. Zink, Midland, MI (US)

(21) Appl. No.: 16/628,274

(22) PCT Filed: Sep. 4, 2018
(86) PCT No.: PCT/US2018/049307

§ 371 Date: Jan. 3, 2020

Related U.S. Application Data
(60) Provisional application No. 62/559,707, filed on Sep. 18, 2017.

(51) Int. Cl. C08G 18/61; C08G 18/18; C08G 18/48; C08G 18/76; C08G 18/20; C08J 9/14

(52) U.S. Cl. CPC C08G 18/61; C08G 18/1816; C08G 18/4816; C08G 18/4829; C08G 2101/00; C08G 18/7664; C08G 18/2036; C08J 9/146; C08G 18/4837

(57) ABSTRACT

A method for producing a polyurethane foam by combining: (a) a polyol; (b) a polyisocyanate; (c) a hydrohaloolefin blowing agent; (d) an amine catalyst; and (e) a polysiloxane.

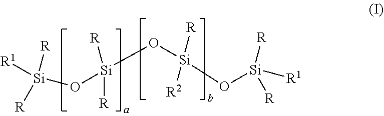

### BACKGROUND

This invention relates generally to a method for producing a stable polyurethane foam using a hydrohaloolefin blowing agent.

In recent years, environmental regulations on hydrofluorocarbon blowing agents has resulted in exploration of hydrohaloolefin blowing agents to make polyurethane foams. However, it has been discovered that hydrohaloolefin blowing agents can interact with other components of a polyurethane formulation, resulting in degradation of one or more of the components and/or blowing agent. For example, hydrohaloolefin blowing agents and tertiary amine catalysts can interact, resulting in decomposition of blowing agent into acidic species that degrade silicone surfactants useful in polyurethane formulations. Several methods have been proposed to avoid such degradation, see, e.g., U.S. Pat. No. 8,906,974. Unfortunately, these methods interfere with reactivity and/or are difficult to implement without expensive modifications.

There is a need for additional solutions to the problem of producing a stable polyurethane foam using a hydrohaloolefin blowing agent. In particular, there is a need to identify a solution that inhibits degradation of silicone surfactants in the presence of hydrohaloolefin blowing agents and amine catalyst.

### Statement of Invention

The present invention provides a solution to the problem of producing a stable polyurethane foam using hydrohaloolefin blowing agent. In particular, the present invention provides a solution to providing a polyurethane foam formulation that has inhibited degradation of silicone surfactants in the presence of hydrohaloolefin blowing agents and amine catalyst.

The present invention is a result of discovering that degradation of silicone surfactant is dependent on specific structural characteristics of the silicone surfactant. In particular, silicone surfactant degradation can be minimized by tuning the siloxane chain segments between polyether attachments. Additionally degradation can be mitigated with specific selection of polyether and siloxane chain terminal substructure.

The present invention is directed to a method for producing a polyurethane foam; said method comprising combining: (a) a polyol; (b) a polyisocyanate; (c) a hydrohaloolefin blowing agent; (d) an amine catalyst and (e) a polysiloxane of formula (I):

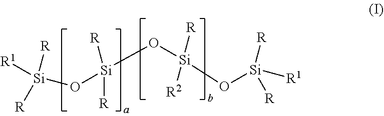

as described in further detail hereinbelow.

### DETAILED DESCRIPTION

All percentages are weight percentages (wt %), and all temperatures are in ° C., unless otherwise indicated. Measurements and reactions have been carried out at ambient temperature (20-25° C.) unless otherwise specified. Alkyl groups are saturated hydrocarbyl groups that may be straight or branched. Preferably, alkyl groups have from one to twelve carbon atoms. Preferably, alkyl groups are unsubstituted. Aryl groups are substituent groups having from six to twenty carbon atoms, preferably six to twelve carbon atoms, which are derived from aromatic hydrocarbon compounds which can be mono- or poly-nuclear. Aryl groups may be substituted by C₁-C₄ alkyl and/or C₁-C₄ alkoxy groups. Preferably, aryl groups are unsubstituted. Numerical subscripts, e.g., a, b, g and h represent number averages and are not necessarily integers. All ranges include end points unless otherwise stated.

The method of the present invention comprises combining: (a) a polyol; (b) a polyisocyanate; (c) a hydrohaloolefin blowing agent; (d) an amine catalyst; and (e) a polysiloxane of formula (I). After combining the components, allow the combination to expand into a polyurethane foam.

Suitable polyols include polyether and polyester polyols. Polyester polyols are based on esters of polybasic carboxylic acids with polyhydric alcohols. The polyols can be aliphatic or aromatic.

Suitable polyisocyanates include isocyanates having two or more isocyanate functionalities, such as for example, one or more than one polyisocyanate selected from a group consisting of 4,4′-diphenylmethane diisocyanate (MDI), toluene diisocyanate (TDI), hexamethylene diisocyanate (HMDI) and isophorone diisocyanate (IPDI). Particularly desirably is a mixture of MDI and more highly condensed analogs having an average functionality in the range of from 2 to 4, which is known as “polymeric MDI” (crude MDI), as well as various isomers of TDI in pure form or as someric mixtures.

The ratio of polyol to polyisocyanate is typically expressed in terms of an “isocyanate index” (or “Iso Index”). The Iso Index is a measure of the stoichiometric balance between equivalents of isocyanate and the total equivalents of isocyanate reactant functionalities. The Iso Index is a molar ratio of isocyanate functionality to isocyanate-reactive functionality (for example, —OH functionality from the polyol) multiplied by 100. Desirable Iso Index ranges for the present invention are in a range of 50 to 450.

Preferably, the hydrohaloolefin blowing agent is a C₂-C₄ alkene having from 3 to 6 halo groups, preferably chloro and/or fluoro groups. Preferred hydrohaloolefin blowing agents include trans-1-chloro-3,3,3-triflouroprop-1-ene, trans 1,3,3,3-tetrafluoropropene and 1,1,1,4,4,4-hexafluorobutene (HFO-1336mzz).

Suitable amine catalysts include tri ethylamine, dimethylcyclohexylamine, tetramethylethylene diamine, tetramethylhexanediamine, pentamethyldiethylenetriamine, pentamethyldipropylenetri amine, triethylenediamine, dimethylpiperazine, 1,2-dimethylimidazole, N-ethylmorpholine, tris(dimethylaminopropyl) hexahydro-1,3,5-triazine, dimethylaminoethanol, dimethylaminoethoxyethanol and bis(dimethylaminoethyl) ether. The amine catalyst can be combined with a metal-containing compound such as, for example, tin compunds such as dibutyltin dilaurate or tin(II) 2-ethylhexanoate and potassium salts like potassium acetate and potassium 2-ethylhaxanoate. Desirably, the concentration of amine catalyst is in a range of 0.05 to 5 weight parts per hundred weight parts of polyol.

The polysiloxane has the structure of formula (I):

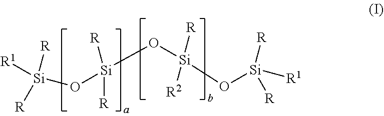

wherein:

“a” is a number in a range of 20 to 130. Desirably, “a” is 25 or more, preferably 30 or more and at the same time is desirably 100 or less, preferably 80 or less, 70 or less and can be 60 or less.

“b” is a number in a range of 1 to 12. Desirably, “b” is one or more and at the same time 10 or less, preferably 8 or less and more preferably 5 or less.

“R” independently in each occurrence represents a C₁-C₁₀ alkyl group, preferably a C₁-C₆ alkyl group and more preferably a C₁-C₄ alkyl group, even more preferably a group selected from methyl and ethyl and most preferably methyl. Desirably, R is the same in each occurrence.

“R¹” independently in each occurrence represents R² or R groups.

“R²” is —F[G_{g}R⁹ₕ]R³; “R³” is alkyl, acyl, or hydrogen. Desirably, when R³ is an alkyl it has one or more carbon atoms and at the same time has six or fewer, preferably, four or fewer and even more preferably has two or fewer carbon atoms. Desirably when R³ is acyl the acyl has two or more carbons and at the same time six or fewer, preferably four or fewer carbons and most preferably has two carbons. Preferably, R³ is methyl, acetyl, or hydrogen; preferably methyl or hydrogen. Preferably, R⁴ is alkyl, preferably C₁-C₄ alkyl, preferably methyl or ethyl, preferably methyl

“F” is difunctional alkyl group having from one to ten carbon atoms which is terminated by an oxygen atom. Preferably, F has two carbon atom or more and at the same time eight carbons or fewer, more preferably six carbons or fewer and even more preferably four carbons or fewer Desirably, F is linear.

“G” is —CH₂CH₂O-,

“R⁹” is —CH₂CH(R⁴)O-,

“R⁴” is alkyl or aryl, preferably a C₁-C₄ alkyl and more preferably methyl or ethyl and most preferably methyl.

“g” is a number in a range of 0 to 50. Desirably, g is 5 or more, preferably 10 or more, 12 or more and even 14 or more while at the same time is desirably 40 or less, preferably 30 or less, more preferably 26 or less.

“h” is a number in a range of 0 to 50. Desirably, h is at least one, preferably 2 or more, more preferably three or more, more preferably four or more and at the same time is desirably 40 or less, preferably 30 or less, more preferably 20 or less and most preferably 10 or less.

Desirably, the value of g+h is 15 or more, preferably 18 or more, more preferably 20 or more and at the same time is 50 or less, preferably 40 or less and more preferably 35 or less.

Desirably, the value of a/(b+1) is greater than 10, preferably greater than 11 if R¹═R. At the same time, the value of a/(b+1) is desirably greater than 12, preferably greater than 13, more preferably greater than 14, even more preferably greater than 15 and most preferably greater than 16 if R¹═R². At the same time as these aforementioned preference of this paragraph, the value of a/(b+1) is desirably less than 40, preferably less than 35 and more preferably less than 30 and most preferably less than 25.

The method is applicable to one-shot and two component polyurethane foam systems. In a two-component polyurethane system comprising a polyol and a polyisocyanate, preferably each polyol component has from two to four isocyanate-reactive groups, preferably amino and hydroxyl groups, preferably hydroxyl groups. Polyether and polyester polyols typically used to make polyurethane foams are preferred. Preferably, each polyisocyanate component has from two to four isocyanate groups. Polymeric isocyanates comprising diphenylmethane diisocyanate (MDI) and its oligomers and having an average functionality from two to four are preferred. Other suitable polyisocyanates include toluene diisocyanate, hexamethylene diisocyanate and isophorone diisocyanate.

In the two-component urethane system, the relative proportions of isocyanate groups to isocyanate-reactive groups may vary as desired, preferably within a molar ratio of NCO/OH groups of 0.9:1 to 2:1. Preferably, the NCO/OH group molar ratio is from 1:1 to 1.8:1, alternatively from 1.1:1 to 1.6:1, alternatively from 1.1:1 to 1.4:1.

The two components of the urethane system preferably are mixed using a suitable mixer (e.g., an electrically, pneumatically, or an otherwise powered mechanical mixer, or a static mixer) prior to or during application to form a foam. Thus, the isocyanate component typically will be packaged separately from the polyol component. Mixing may take place at ambient room temperature or supra-ambient conditions. For example, the two components may be heated just prior to mixing and applied at elevated temperature during the coating and lamination process. Preferably, the temperature does not exceed 65° C.

### EXAMPLES

### Synthetic Preparations (Comparative Examples)

Materials: DC MH1107 fluid 30 centistoke (cSt), DC 244 fluid, DC 200 fluid, 0.65 cSt, 2,4,6,8,10-pentamethylcyclopentasiloxane, and 1,1,3,3-tetramethyldisiloxane were supplied internally by Dow Corning. Trifluoromethanesulfonic acid (CAS 1493-13-6) and sodium bicarbonate (CAS 144-55-8) were purchased from Sigma-Aldrich. Allyl polyether materials were purchased from various polyether suppliers such as Dow, NOF, Huang Ma, and Huntsman.

Equilibration of SiH material: the components noted in Tables 1 and 2 below are added to a 3-neck flask equipped with a mechanical stirrer, a thermocouple, and a water-cooled condenser. The reaction flask is flushed with nitrogen for several minutes; however, the nitrogen flow is turned off during the reaction due to the use of volatile components. The reaction mixture is heated to 60° C., catalyzed with 500 ppm trifluoromethanesulfonic acid, and heated at 60° C. for 8 additional hours before it is neutralized using sodium bicarbonate (10 g sodium bicarbonate per 1 mL acid used) and cooled overnight while maintaining stirring. The resulting mixture is filtered and the volatile contents of the liquid portion is removed with vacuum distillation at 150° C. and 15 mmHg vacuum for up to 5 hours. The resulting polymeric structure is characterized using ²⁹Si nuclear magnetic resonance spectroscopy (NMR) and Fourier transform infrared spectroscopy (FTIR) and the product is used without further purification.

TABLE 1

| | | | Formulation (%) | | |
|---|---|---|---|---|---|
| Siloxanes | | | DC | | |
| to make | | | MH1107 | DC | DC 200 |
| examples | R¹ = CH₃ | | fluid | 244 | fluid, |
| below | a | b | 30 cSt | fluid | 0.65 cSt |
| C. Ex1 | 58 | 7 | 8.67 | 89.04 | 2.29 |
| C. Ex2, 9 | 10 | 4 | 21.64 | 66.94 | 11.42 |
| C. Ex3 | 30 | 4 | 9.26 | 85.86 | 4.89 |
| C. Ex8 | 55 | 7.5 | 9.73 | 87.94 | 2.33 |
| C. Ex10 | 10 | 12.5 | 47.65 | 47.16 | 5.20 |
| C. Ex11 | 50 | 7 | 9.77 | 87.67 | 2.56 |
| C. Ex12 | 18 | 2 | 7.53 | 83.86 | 8.61 |

TABLE 2

| Siloxanes to | | | Formulation (%) | | |
|---|---|---|---|---|---|
| make | | | 2,4,6,8,10- | | 1,1,3,3- |
| examples | R¹ = R² | | pentamethylcyclo- | DC 244 | tetramethyl- |
| below | a | b | pentasiloxane | Fluid | disiloxane |
| C. Ex4, 6, 13 | 25 | 1 | 2.94 | 90.51 | 6.56 |
| C. Ex5 | 24 | 3 | 8.61 | 84.97 | 6.41 |
| C. Ex7 | 15 | 5 | 19.43 | 71.89 | 8.68 |

Silicone polyether synthesis: The silicone and allyl polyether are loaded into a 3-neck flask equipped with a mechanical stirrer, a thermocouple, and a water-cooled condenser. The formulation for each example, in weight percentages, is listed in Table 3 below. The reaction mixture is heated to 70° C. under a nitrogen flow and then catalyzed with a Pt(IV) solution in isopropanol (5 ppm Pt). The reaction mixture becomes turbid and an exotherm is observed, after which the heating is raised to 90° C. The SiH level is measured using FTIR once the reaction temperature reaches 90° C. For reactions that contain greater than 5% residual SiH, additional 5 ppm Pt is added and the reactions are held at 90° C. until the SiH level become satisfactory, up to 9 hours. The reaction is stopped by cooling the mixture down to room temperature and used without further purification. The final product, typically a clear to slightly hazy golden material, is tested for SiH level using ¹H NMR verify the reaction is complete (<5% residual SiH).

TABLE 3

| | | | | | | | | | | Formulation | |
|---|---|---|---|---|---|---|---|---|---|---|---|
| | | | | | | R² | | | | (%) | |
| | R¹ | R | a | b | P | F | g | h | R³ | Silox | Vinyl |
| C. | CH₃ | CH₃ | 58 | 7 | 7.3 | —CH₂CH₂CH₂O— | 10 | 4 | H | 42.10 | 57.90 |
| Ex1 | | | | | | | | | | | |
| C. | CH₃ | CH₃ | 10 | 4 | 2 | —CH₂CH₂CH₂O— | 12 | 0 | H | 27.07 | 72.93 |
| Ex2 | | | | | | | | | | | |
| C. | CH₃ | CH₃ | 30 | 4 | 6 | —CH₂CH₂CH₂O— | 10 | 4 | H | 40.63 | 59.37 |
| Ex3 | | | | | | | | | | | |
| C. | R² | CH₃ | 25 | 1 | 12.5 | —CH₂CH₂CH₂O— | 13 | 6 | H | 34.69 | 65.31 |
| Ex4 | | | | | | | | | | | |
| C. | R² | CH₃ | 24 | 3 | 6 | —CH₂CH₂CH₂O— | 13 | 6 | CH₃ | 24.32 | 75.68 |
| Ex5 | | | | | | | | | | | |
| C. | R² | CH₃ | 25 | 1 | 12.5 | —CH₂CH₂CH₂O— | 13 | 6 | CH₃ | 34.37 | 65.63 |
| Ex6 | | | | | | | | | | | |
| C. | R² | CH₃ | 15 | 5 | 2.5 | —CH₂CH₂CH₂O— | 13 | 6 | H | 14.67 | 85.33 |
| Ex7 | | | | | | | | | | | |
| C. | CH₃ | CH₃ | 55 | 7.5 | 6.5 | —CH₂CH₂CH₂O— | 10 | 4 | H | 39.46 | 60.54 |
| Ex8 | | | | | | | | | | | |
| C. | CH₃ | CH₃ | 10 | 4 | 2 | —CH₂CH₂CH₂O— | 12 | 0 | C(O)CH₃ | 25.73 | 74.27 |
| Ex9 | | | | | | | | | | | |
| C. | CH₃ | CH₃ | 10 | 12.5 | 0.7 | —CH₂CH₂CH₂O— | 8 | 0 | CH₃ | 19.18 | 80.82 |
| Ex10 | | | | | | | | | | | |
| C. | CH₃ | CH₃ | 50 | 7 | 6.3 | —CH₂CH₂CH₂O— | 11 | 3.5 | H | 38.49 | 61.51 |
| Ex11 | | | | | | | | | | | |
| C. | CH₃ | CH₃ | 18 | 2 | 6 | —CH₂CH₂CH₂O— | 21 | 5 | CH₃ | 32.37 | 67.63 |
| Ex12 | | | | | | | | | | | |
| C. | R² | CH₃ | 25 | 1 | 12.5 | —CH₂CH₂CH₂O— | 21 | 5 | CH₃ | 28.78 | 71.22 |
| Ex13 | | | | | | | | | | | |

P = a/(b + 1)

TABLE 4

| | Formulation 1 |
|---|---|
| Components | Parts |
| A-side | |
| Polymeric MDI (% NCO = 31.4) | 133.65 |
| B-side | |
| Polyol blend (OH# 327) | 97.30 |
| Water | 2.7 |
| Surfactant (various) | 2.5 |
| DMCHA | 1.00 |
| 1,3,5-tris(3-(dimethylamino)propyl)- | 0.60 |
| hexahydro-s-triazine | |
| Trans- 1-chloro-3,3,3-trifluoropropene | 12.8 |
| (1233zd(E)) | |

Detailed description of materials used in foam formulations are given in Table 5.

TABLE 5

| Material | Chemical Name | Supplied by | CAS #(s) | Notes |
|---|---|---|---|---|
| Polyol Blend | Glycerol propylene oxide | The Dow | 25791-96-2 | OH# |
| | Sucrose, propylene oxide | Chemical | 9049-71-2 | 327 |
| | Glycerol, propylene oxide, | Company | 9082-00-2 | |
| | ethylene oxide | | | |
| | Tris (1-chloro-2propyl) | | 13674-84-5 | |
| | phosphate (TCPP) | | | |
| PAPI ™ 27 | Polymethylene | The Dow | 9016-87-9 | % NCO |
| | polyphenylisocyanate | Chemical | | 31.4 |
| | | Company | | |
| JEFFCAT ™ | N,N-dimethyl | Huntsman | 98-94-2 | |
| DMCHA | cyclohexylamine | | | |
| Amine Catalyst | | | | |
| JEFFCAT | 1,3,5-tris(3- | Hunstman | 15875-13-5 | |
| TR-90 Amine | (diethlamino)propyl)hexahydro- | | | |
| Catalyst | s-triazine | | | |
| DABCO ™ | 70% potassium octoate in | Air Products | 3164-85-0, | |
| K-15 | diethylene glycol | | 111-46-6 | |
| SOLSTICE ™ | Trans-1-chloro-3,3,3- | Honeywell | 102687-65- | |
| LBA | triflouroprop-1-ene | | 0 | |
| ENOVATE ™ | 1,1,1,3,3,-pentafluoropropane | Honeywell | 460-73-1 | |
| 245fa | | | | |
| Surfactant | Various comparative and | Dow Corning | Various | |
| | inventive | Corporation | | |

PAPI is a trademark of The Dow Chemical Company. JEFFCAT is a trademark of JPMorgan Chase Bank, N.A. DABCO is a trademark of Air Products and Chemicals, Inc. ENOVATE and SOLSTICE are a trademarks of Honeywell International, Inc.

Cup foams were prepared by blending B-side and A-side with the ratio shown in Table 4 initially, after 1 week in 50° C. and after 2 week in 50° C. Quality of each foam sample was graded based on visual observation of the cross section of the foam after cutting. The rating scale was 1 to 20 where 1 was the best quality and 20 was the worst. If foam quality was judged greater than 5, subsequent testing was not carried out. A rating of 1 was the best possible quality, as indicated by the light beige color and fine uniform surface. A rating of 20 corresponds to completely collapsed foam with a dark brown color. As the color increased from beige to yellow to brown and the foam surface holes and imperfections increased to more and larger holes the rating number increased accordingly. Evaluation results for comparative examples are shown in Tables 6 and 7.

TABLE 6
Comparative Examples

| Formulation examples | 14 | 15 | 16 | 17 | 18 | 19 |
|---|---|---|---|---|---|---|
| Surfactant in formulation | Ex1 | Ex2 | Ex3 | Ex4 | Ex5 | Ex6 |
| Initial foam | 1 | 1 | 1 | 1 | 1 | 1 |
| quality | | | | | | |
| Foam quality after | 3 | 9 | 8 | 1 | 7 | 1 |
| 1 week at 50° C. | | | | | | |
| Foam quality after | 16 | — | — | 7 | — | 3 |
| 2 week at 50° C. | | | | | | |

TABLE 7
Comparative Examples

| Formulation examples | 20 | 21 | 22 | 23 | 24 | 25 | 26 |
|---|---|---|---|---|---|---|---|
| Surfactant in formulation | Ex7 | Ex8 | Ex9 | Ex10 | Ex11 | Ex12 | Ex13 |
| Initial foam | 1 | 1 | 1 | 11 | 1 | 1 | 1 |
| quality | | | | | | | |
| Foam quality after | 13 | 7 | 12 | — | 10 | 5 | 1 |
| 1 week at 50° C. | | | | | | | |
| Foam quality after | — | — | — | — | — | 17 | 8 |
| 2 week at 50° C. | | | | | | | |

The results demonstrate that the foam degrades in all of the comparative examples, including structures known in the prior art, when halogenated olefin blowing agent is used.

### Synthetic Preparations (Inventive Examples)

Materials: DC MH1107 fluid 30 cSt, DC 244 fluid, DC 200 fluid, 0.65 cSt, 2,4,6,8,10-pentamethylcyclopentasiloxane, and 1,1,3,3-tetramethyldisiloxane were supplied internally by Dow Corning. Trifluoromethanesulfonic acid (CAS 1493-13-6) and sodium bicarbonate (CAS 144-55-8) were purchased from Sigma-Aldrich. Allyl polyether materials were purchased from polyether suppliers such as Dow, NOF, Huang Ma, and Huntsman

Equilibration of SiH material: the components noted Tables 8 and 9 below are added to a 3-neck flask equipped with a mechanical stirrer, a thermocouple, and a water-cooled condenser. The reaction flask is flushed with nitrogen for several minutes; however, the nitrogen flow is turned off during the reaction due to the use of volatile components. The reaction mixture is heated to 60° C., catalyzed with 500 ppm trifluoromethanesulfonic acid, and heated at 60° C. for 8 additional hours before it is neutralized using sodium bicarbonate (10 g sodium bicarbonate per 1 mL acid used) and cooled overnight while maintaining stirring. The resulting mixture is filtered and the volatile contents of the liquid portion is removed with vacuum distillation at 150° C. and 15 mmHg vacuum for up to 5 hours. The resulting polymeric structure is characterized using ²⁹Si NMR and FTIR and the product is used without further purification.

TABLE 8

| Siloxanes to | | | Formulation (%) | | |
|---|---|---|---|---|---|
| make | | | | DC | DC 200 |
| examples | R¹ = CH₃ | | DC MH1107 | 244 | fluid, 0.65 |
| below | a | b | fluid 30 cSt | fluid | cSt |
| C. Ex40 | 56 | 7 | 8.96 | 88.68 | 2.36 |
| C. Ex41 | 48 | 5 | 7.52 | 89.43 | 3.05 |
| C. Ex42 | 42 | 6 | 9.83 | 86.99 | 3.17 |
| Inv Ex44, 45 | 50 | 3 | 4.46 | 92.26 | 3.28 |

TABLE 9

| Siloxanes | | | Formulation (%) | | |
|---|---|---|---|---|---|
| to make | | | 2,4,6,8,10- | DC | 1,1,3,3- |
| examples | R¹ = R² | | pentamethyl- | 244 | tetramethyl- |
| below | a | b | cyclopentasiloxane | fluid | disiloxane |
| C. Ex43 | 25 | 1 | 2.94 | 90.51 | 6.56 |
| Inv Ex46, | 35 | 1 | 2.16 | 93.03 | 4.81 |
| 47 | | | | | |

Silicone polyether synthesis: The silicone and allyl polyether are loaded into a 3-neck flask equipped with a mechanical stirrer, a thermocouple, and a water-cooled condenser. The formulation for each example, in weight percentages, is listed in Table 10 below. The reaction mixture is heated to 70° C. under a nitrogen flow and then catalyzed with a Pt(IV) solution in isopropanol (5 ppm Pt). The reaction mixture becomes turbid and an exotherm is observed, after which the heating is raised to 90° C. The SiH level is measured using FTIR once the reaction temperature reaches 90° C. For reactions that contain greater than 5% residual SiH, additional 5 ppm Pt is added and the reactions are held at 90° C. until the SiH level become satisfactory, up to 9 hours. The reaction is stopped by cooling the mixture down to room temperature and used without further purification. The final product, typically a clear to slightly hazy golden material, is tested for SiH level using ¹H NMR verify the reaction is complete (<5% residual SiH).

TABLE 10

| | | | | | | | | | | Formulation | |
|---|---|---|---|---|---|---|---|---|---|---|---|
| | | | | | | R² | | | | (%) | |
| | R¹ | R | a | b | P | F | g | h | R³ | Silox | Vinyl |
| C. Ex40 | CH₃ | CH₃ | 56 | 7 | 7 | —CH₂CH₂CH₂O— | 12 | 3 | H | 40.37 | 59.63 |
| C. Ex41 | CH₃ | CH₃ | 48 | 5 | 8 | —CH₂CH₂CH₂O— | 12 | 3 | H | 44.60 | 55.40 |
| C. Ex42 | CH₃ | CH₃ | 42 | 6 | 6 | —CH₂CH₂CH₂O— | 12 | 3 | H | 37.76 | 62.24 |
| C. Ex43 | R² | CH₃ | 25 | 1 | 12.5 | —CH₂CH₂CH₂O— | 13 | 7 | CH₃ | 33.10 | 66.90 |
| Inv Ex44 | CH₃ | CH₃ | 50 | 3 | 12.5 | —CH₂CH₂CH₂O— | 16 | 6 | H | 48.07 | 51.93 |
| Inv Ex45 | CH₃ | CH₃ | 50 | 3 | 12.5 | —CH₂CH₂CH₂O— | 16 | 6 | CH₃ | 47.75 | 52.25 |
| Inv Ex46 | R² | CH₃ | 35 | 1 | 17.5 | —CH₂CH₂CH₂O— | 23 | 7 | CH₃ | 32.20 | 67.80 |
| Inv Ex47 | R² | CH₃ | 35 | 1 | 17.5 | —CH₂CH₂CH₂O— | 23 | 7 | H | 32.41 | 67.59 |

TABLE 11

| | Formulation 3 |
|---|---|
| Components | Parts |
| A-side | |
| Polymeric MDI (% NCO = 31.4) | 133.65 |
| B-side | |
| Polyol blend (OH# 327) | 97.30 |
| Water | 2.7 |
| Surfactant (various) | 2.5 |
| DMCHA | 1.00 |
| 1,3,5-tris(3-(dimethylamino)propyl)- | 0.60 |
| hexahydro-s-triazine | |
| 1,1,1,3,3,-pentafluoropropane | 12.8 |
| (HFC-245fa) | |

Foams were prepared with formulation 3 containing non-olefin blowing agent according to Table 11. Cup foams were prepared by blending B-side and A-side with the ratio shown in Table 11 initially, after 1 week in 50° C. and after 2 week in 50° C. Quality of each foam sample was graded based on visual observation of the cross section of the foam after cutting. The rating scale was 1 to 20 where 1 was the best quality and 20 was the worst. If foam quality was judged greater than 5, subsequent testing was not carried out. A rating of 1 was the best possible quality, as indicated by the light beige color and fine uniform surface. A rating of 20 corresponds to completely collapsed foam with a dark brown color. As the color increased from beige to yellow to brown and the foam surface holes and imperfections increased to more and larger holes the rating number increased accordingly. Evaluation results for comparative and inventive examples are shown in Table 12. Table 12 shows the results with 1,1,1,3,3,-pentafluoropropane blowing agent using Formulation 3. This indicates that both comparative and inventive examples work equally well with non-olefin halogenated blowing agent.

TABLE 12
Results with 1,1,1,3,3,-pentafluoropropane

| | Comparative Examples | | | | Inventive Examples | | | |
|---|---|---|---|---|---|---|---|---|
| Formulation examples | Ex48 | Ex49 | Ex50 | Ex51 | Ex52 | Ex53 | Ex54 | Ex55 |
| Surfactant in formulation | Ex40 | Ex41 | Ex42 | Ex43 | Ex44 | Ex45 | Ex46 | Ex47 |
| Initial foam quality | 1 | 1 | 1 | 1 | 1 | 1 | 1 | 1 |
| Foam quality >1 week at 50° C. | 1 | 1 | 1 | 1 | 1 | 1 | 1 | 1 |
| Foam quality >2 weeks at 50° C. | 1 | 1 | 1 | 1 | 1 | 1 | 1 | 1 |

TABLE 13

| | Formulation 1 |
|---|---|
| Components | Parts |
| A-side | |
| Polymeric MDI (% NCO = 31.4) | 133.65 |
| B-side | |
| Polyol blend (OH# 327) | 97.30 |
| Water | 2.7 |
| Surfactant (various) | 2.5 |
| DMCHA | 1.00 |
| 1,3,5-tris(3-(dimethylamino)propyl)- | 0.60 |
| hexahydro-s-triazine | |
| Potassium 2-ethylhexanoate (in 30% | |
| Diethylene glycol) | |
| Trans- 1-chloro-3,3,3-trifluoropropene | 12.8 |
| (1233zd(E)) | |

Foams were prepared with formulation 1 containing halogenated olefin blowing agent according to Table 13. Cup foams were prepared by blending B-side and A-side with the ratio shown in Table 13 initially, after 1 week in 50° C. and after 2 week in 50 ° C. Quality of each foam sample was graded based on visual observation of the cross section of the foam after cutting. The rating scale was 1 to 20 where 1 was the best quality and 20 was the worst. If foam quality was judged greater than 5, subsequent testing was not carried out. A rating of 1 was the best possible quality, as indicated by the light beige color and fine uniform surface. A rating of 20 corresponds to completely collapsed foam with a dark brown color. As the color increased from beige to yellow to brown and the foam surface holes and imperfections increased to more and larger holes the rating number increased accordingly. Evaluation results for comparative and inventive examples are shown in Table 14.

TABLE 14

| With 1233zd(E) | Comparative Examples | | | | Inventive Examples | | | |
|---|---|---|---|---|---|---|---|---|
| Formulation examples | Ex56 | Ex57 | Ex58 | Ex59 | Ex60 | Ex61 | Ex62 | Ex63 |
| Surfactant in formulation | Ex40 | Ex41 | Ex42 | Ex43 | Ex44 | Ex45 | Ex46 | Ex47 |
| Initial foam quality | 1 | 1 | 1 | 1 | 1 | 1 | 1 | 1 |
| Foam quality after 1 week at 50° C. | 2 | 8 | 12 | 1 | 1 | 1 | 1 | 1 |
| Foam quality after 2 week at 50° C. | 11 | 18 | 20 | 3 | 1 | 1 | 1 | 1 |

Table 14 shows the results with 1233zd(E) blowing agent using Formulation 1. This indicates that only inventive examples work with halogenated olefin blowing agent.

1. A method for producing a polyurethane foam; said method comprising combining: (a) a polyol; (b) a polyisocyanate; (c) a hydrohaloolefin blowing agent; (d) and amine catalyst;
and (e) a polysiloxane of formula (I) 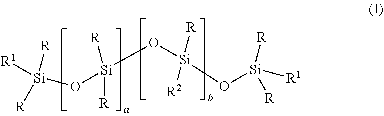
Wherein a is a number in a range of 20 to 130, b is a number in a range of 1 to 12, R represents independently in each occurrence C₁-C₁₀ alkyl groups, R¹ represents independently in each occurrence R² or R groups, R² is —FG_{g}R⁹ₕR³; R³ is alkyl, acyl, or hydrogen; F is a difunctional alkyl group having from one to ten carbon atoms which is terminated by an oxygen atom, G is —CH₂CH₂O-, R⁹ is —CH₂CH(R⁴)O—, R⁴ is alkyl or aryl, g is a number in a range of 0 to 50, and h is a number in a range of 0 to 50; wherein the value of a/(b+1) is greater than 10 if R¹═R and the value of a/(b+1) is greater than 13 if R¹═R².

2. The method of claim 1 in which g is a number in a range of 5 to 40 and h is a number in a range of 2 to 20.

3. The method of claim 2 in which a is a number in a range of 20 to 80 and b is a number in a range of 1 to 6.

4. The method of claim 3 in which R⁴ is C₁-C₄ alkyl, when R³ is alkyl it has from one to six carbon atoms and when R³ is acyl it has from two to six carbon atoms.

5. The method of claim 4 in which R represents C₁-C₄ alkyl groups.

6. The method of claim 5 in which F is —(CH₂)ᵢO, wherein i is an integer from 1 to 8.

7. The method of claim 6 in which the value of g+h is a number in a range of 15 to 40.

8. The method of claim 7 in which the value of a/(b+1) is greater than 1 if R¹═R and a/(b+1) is greater than 14 if R¹═R².

9. The method of claim 8 in which g is a number in a range of 10 to 30 and h is a number in a range of 3 to 10.

10. The method of claim 9 in which R is methyl, a is a number in a range of 25 to 70, b is a number in a range of 1 to 5 and R⁴ is methyl.
